(19) United States
(12) Patent Application Publication
(10) Pub. No.: US 2018/0023968 A1
(43) Pub. Date: Jan. 25, 2018

(54) ROUTE PLANNING APPARATUS AND METHOD

(71) Applicant: Jaguar Land Rover Limited, Coventry. Warwickshire (GB)

(72) Inventors: Phil Stuchfield, Coventry. Warwickshire (GB); Marlon Camps, Coventry. Warwickshire (GB)

(21) Appl. No.: 15/545,917

(22) PCT Filed: Feb. 26, 2016
(86) PCT No.: PCT/EP2016/054043

§ 371 Date: Jul. 24, 2017

(30) Foreign Application Priority Data
Feb. 27, 2015 (GB) 1503359.0

(51) Int. Cl. G01C 21/34; G06F 17/30; G01C 21/36

(52) U.S. Cl. CPC G01C 21/3461; G01C 21/3446; G01C 21/3655; G01C 21/3415; G01C 21/3617; G01C 21/3676; G01C 21/3697; G06F 17/30241; G06F 17/3087; G01C 21/343; H04W 84/12

(57) ABSTRACT

The present disclosure relates to a method of planning a route (R) to a destination (14). A map database (9) defines a road network; and a communications network database (10) defines one or more network parameter for a wireless communication network. The method uses a routing algorithm to plan a route (R) to the destination (14) using the communications network database (10) to estimate connectivity to the wireless communication network along one or more routes generated using the map database (9). The present disclosure also relates to a route planning apparatus (1).

### TECHNICAL FIELD

The present disclosure relates to a route planning apparatus and method. More particularly, but not exclusively, the present disclosure relates to a method of planning a route to a destination; to a route planning apparatus; and to a vehicle having a route planning apparatus.

### BACKGROUND

An occupant in a vehicle, such as an automobile, can connect to a wireless communication network while the vehicle is travelling. The wireless communication network can, for example, be a cellular network. However, when the vehicle is travelling, connectivity to the wireless communication network may vary, for example due to varying network coverage or signal strength. This means that vehicle occupants have unreliable or inconsistent connectivity to the wireless communication network. This problem is compounded by the fact that the occupant cannot determine how the connectivity will vary during a journey.

It is against this background that the present invention has been conceived. At least in certain embodiments, the present invention seeks to overcome or ameliorate at least some of the aforementioned problems.

### SUMMARY OF THE INVENTION

Aspects and embodiments of the present invention relate to a method of planning a route to a destination; to a route planning apparatus; and to a vehicle having a route planning apparatus.

According to a further aspect of the present invention there is provided a method of planning a route to a destination. The method may comprise accessing a map database defining a road network. The method may comprise accessing a communications network database defining one or more network parameter for a wireless communication network. The method may comprise using a routing algorithm to plan a route to the destination using the communications network database to estimate connectivity to the wireless communication network along one or more route generated using the map database. The routing algorithm may use the coverage data to determine connectivity to the wireless communication network for a particular route. The routing algorithm may plan the route in dependence on the connectivity to the wireless communication. The routing algorithm may be defined in software or hardware.

In an embodiment, the routing algorithm can use the communications network database to plan the route to the destination such that a connection to the wireless communication network is maintained for at least a defined portion of the route. The portion of the route for which connection to the wireless communication network is maintained may be specified by a user. Alternatively, the portion of the route could be determined automatically, for example to enable a telephone call or a video call to be conducted whilst the vehicle travels along the planned route.

The routing algorithm may be configured to estimate when and/or where a connection to the wireless communication will be lost. The routing algorithm may be configured to dynamically change the planned route to maintain a connection to the wireless communication network.

The method may comprise quantifying routes in terms of their connectivity to allow the user to make an informed decision as to the appropriate route. For example, the method may comprise specifying a percentage of the journey (for example 95%) for which connection to the wireless communication network is available.

The communications network database may define a network connection type, for example to differentiate between 2G, 3G, 4G and 5G cellular network connections. It will be appreciated that the method can be applied to other types of cellular network connections.

The communications network database may define one or more network parameter. The one or more network parameter may define one or more of the following: signal strength, transfer speeds, dropped call information, data quality, bandwidth, bit error rate, throughput, coverage, bandwidth and network capacity. The signal strength information may, for example, classify a signal as being strong or weak at a particular location. The communications network database may define network provider information (for example transfer speeds, throughput etc.).

The one or more network parameter can be defined throughout a geographic region corresponding to the road network defined by the map database. Alternatively, the one or more network parameter can be defined in those regions proximal to the roads making up the road network.

The routing algorithm may use the communications network database to plan the route to the destination to avoid areas in which the one or more network parameter is below one or more defined threshold. The routing algorithm may use the communications network database to plan the route to the destination to remain in areas in which the one or more network parameter is above one or more defined threshold.

The communications network database may define location information of one or more local area wireless connections. The local area wireless connection can be a Wi-Fi connection, for example. The one or more network parameter could also identify those local area wireless connections that are available for connection, for example those operated by a chain of restaurants or cafés.

The one or more network parameter could be updated periodically, for example by synchronising the communications network database with a centralised database. Alternatively, or in addition, the one or more network parameter for the wireless communication network may comprise historic data collected during one or more previous journeys. The route planning apparatus could collect data relating to network type (for example 2G, 3G, 4G, 5G cellular networks); local area wireless connections (for example the location and signal strength of a WiFi connection); dropped call information; network provider information (for example transfer speeds, throughput etc.). Thus, the historic data may be collected during any journey and used to update the communications network database. The collected information may, for example, be collated with tracking information from a navigation positioning system module.

The method may comprise using a diary database to identify a scheduled time for an event requiring access to the wireless communication network. The routing algorithm may be configured to plan the route such that a connection to the wireless communication network is available at the scheduled time. The routing algorithm may be configured to schedule a stop at the scheduled time in a location where the connection to the wireless communication network is available. This may, for example, allow the user to park the vehicle and connect to the wireless communication network at the scheduled time, for example to conduct a telephone or video call.

The method may comprise using a display screen to display one or more network parameter over the road network. The one or more network parameter may be displayed in one or more layer. A different network parameter may be displayed in each layer. The one or more layer may define one or more of the following: 2G coverage, 3G coverage, 4G coverage, 5G coverage, local area wireless connection (such as Wi-Fi) coverage, dropped calls, network providers, signal strength, transfer speeds, etc. Each layer may be added over the route map to show the signal strength along a planned route.

According to a further aspect of the present invention there is provided a route planning apparatus. The apparatus may comprise a controller comprising an electronic processor. The apparatus may comprise an electronic memory device electrically coupled to the electronic processor and having instructions stored therein. The electronic processor may be configured to access the memory device and execute the instructions stored therein such that it is operable to access a map database defining a road network and/or access a communications network database defining one or more network parameter for a wireless communication network and/or implement a routing algorithm to plan a route to the destination using the communications network database to estimate connectivity to the wireless communication network along one or more routes generated using the map database.

The routing algorithm may use the communications network database to plan the route to the destination such that a connection to the wireless communication network is maintained for at least a defined portion of the route.

The routing algorithm may be configured to estimate when and/or where a connection to the wireless communication will be lost. The routing algorithm may dynamically change the planned route to maintain a connection to the wireless communication network.

The communications network database may define a network connection type, for example to differentiate between 2G, 3G, 4G and 5G cellular network connections.

The communications network database may define one or more network parameters. The one or more network parameter may define one or more of the following: signal strength, transfer speeds, dropped call information, data quality, bandwidth, bit error rate, throughput, coverage, bandwidth and network capacity. The communications network database may define network provider information (for example transfer speeds, throughput etc.).

The routing algorithm may use the communications network database to plan the route to the destination to avoid areas in which the one or more network parameter is below one or more defined threshold. The user may have an important call that they do not want to drop, so the route may be based on having good connectivity throughout journey avoiding any areas of weak coverage. The route may be generated based on maintaining connectivity. This route could be presented to the user as one of several possible routes.

The routing algorithm may use the communications network database to plan the route to the destination to remain in areas in which the one or more network parameter is above one or more defined threshold.

The communications network database may define location information of one or more local area wireless connections. The local area wireless connections may, for example, be a Wi-Fi connection.

The one or more network parameter may comprise historic data collected during one or more previous journeys. The route planning apparatus could collect data relating to network type (for example 2G, 3G, 4G, 5G cellular networks); local area wireless connections (for example location and signal strength of a WiFi connection); dropped call information; network provider information (for example transfer speeds, throughput etc.).

The electronic processor may be configured to access a diary database to identify a scheduled time for an event requiring access to the wireless communication network. The routing algorithm may be configured to plan the route such that a connection to the wireless communication network is available at the scheduled time. The routing algorithm may be configured to schedule a stop at the scheduled time in a location where the connection to the wireless communication network is available.

The route planning apparatus may comprise a display screen for displaying the one or more network parameter and the road network. The one or more network parameter may be overlaid onto the road network. The one or more network parameter may be displayed in one or more layer. A different network parameter may be displayed in each layer. The one or more layer may define one or more of the following: 2G coverage, 3G coverage, 4G coverage, 5G coverage, local area wireless connection (such as Wi-Fi) coverage, dropped calls, network providers, signal strength, transfer speeds, etc. Each layer may be added over the route map to show the one or more network parameter along a planned route.

According to a further aspect of the present invention there is provided a vehicle comprising a route planning apparatus as described herein.

The route planning apparatus has been described herein with reference to a plurality of databases, including the map database and the communications network database. It will be appreciated that these databases may be maintained independently of each other or may be combined. The databases may be stored in one or more electronic memory devices.

Any controller or controllers described herein may suitably comprise a control unit or computational device having one or more electronic processors. Thus the system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. A first controller may be implemented in software run on one or more processors. One or more other controllers may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the present invention will now be described, by way of example only, with reference to the accompanying figures, in which:

FIG. 1 shows a schematic representation of a route planning apparatus in accordance with an embodiment of the present invention;

FIG. 2 shows a first representative image generated by the route planning apparatus combining route planning and wireless network connectivity; and

FIG. 3 shows a second representative image generated by the route planning apparatus combining route planning and local area wireless connection.

### DETAILED DESCRIPTION

A route planning apparatus 1 in accordance with an embodiment of the present invention will now be described with reference to the accompanying figures. The route planning apparatus 1 is configured to plan a route taking into account connectivity to a wireless communication network. The route planning apparatus 1 is suitable for use in a vehicle 2, such as an automobile. The route planning apparatus 1 could be integrated into a vehicle infotainment system; or could be an aftermarket device, for example configured to be mounted to a windshield or dashboard of the vehicle.

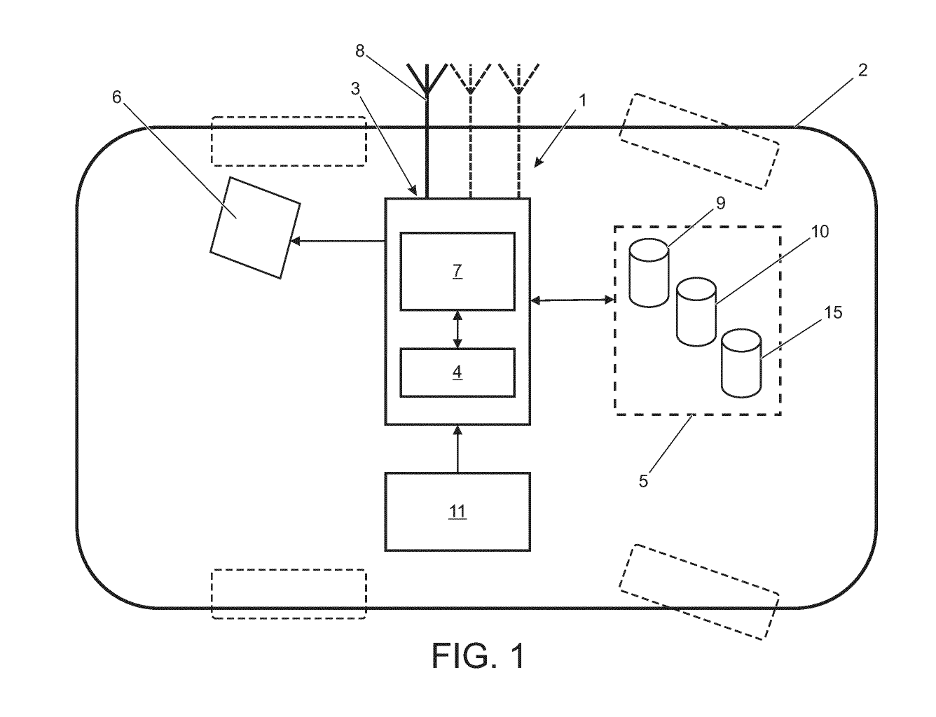

As shown in FIG. 1, the route planning apparatus 1 comprises an electronic control unit 3, system memory 4, a storage device 5 and a display screen 6. The electronic control unit 3 comprises at least one electronic processor 7 configured to execute a set of software instructions stored in the system memory 4 to implement a routing algorithm to plan a route. The electronic control unit 3 is connected to one or more antenna 8 for receiving and/or transmitting radio frequency (RF) signals. The antenna 8 can be provided in the vehicle 2 as part of an on-board communications system, for example to provide cellular telephone connections, data transfer and navigation functions. A map database 9 and a communications network database 10 are stored on the storage device 5. The electronic control unit 3 is coupled to the storage device 5 and accesses the map database 9 and the communications network database 10 to plan the route. The electronic control unit 3 is connected to a navigation positioning system module 11 (such as GPS, Glonass, Galileo etc.) which operates in conventional manner to generate position data.

The map database 9 defines a road network in a geographic region, such as the United Kingdom, Europe or the United States of America. The communications network database 10 defines one or more network parameter for a wireless communication network. The wireless communication network is typically a cellular communication network for voice calls and/or data transfer. The communication network database 10 defines a signal strength to provide an indication of the local connectivity to the cellular communication network. The communication network database 10 can define the signal strength throughout the geographic region covered by the road network in the map database 9. In a variant, the signal strength could be defined along the road network in the map database 9. The communications network database 10 could be updated periodically, for example based on data obtained from network service provides. In addition to signal strength, the communication network database 10 can define other network parameter(s), such as one or more of the following: data quality, bandwidth, bit error rate, throughput, coverage, bandwidth, network capacity etc.

The communication network database 10 could be updated periodically, for example along with any system updates when the route planning apparatus 1 is synchronised. In the present embodiment the route planning apparatus 1 uses the antenna 8 to measure signal strength and to update the communications network database 10 with reference to the position data generated by the navigation positioning system module 11. The communication network database 10 can thereby be updated dynamically, for example as the vehicle 2 is travelling along a route. The communications network database 10 can, for example, store historic data relating to n routes (where n≧1) completed by the vehicle 2. The historic data can relate to the last n routes, the best n routes, etc. By way of example, the historic data can be derived from ten (10) routes. Alternatively, the historic data can correspond to the actual coverage during the preceding n weeks or months (where n≧1); or the number of calls dropped during the preceding n weeks or months.

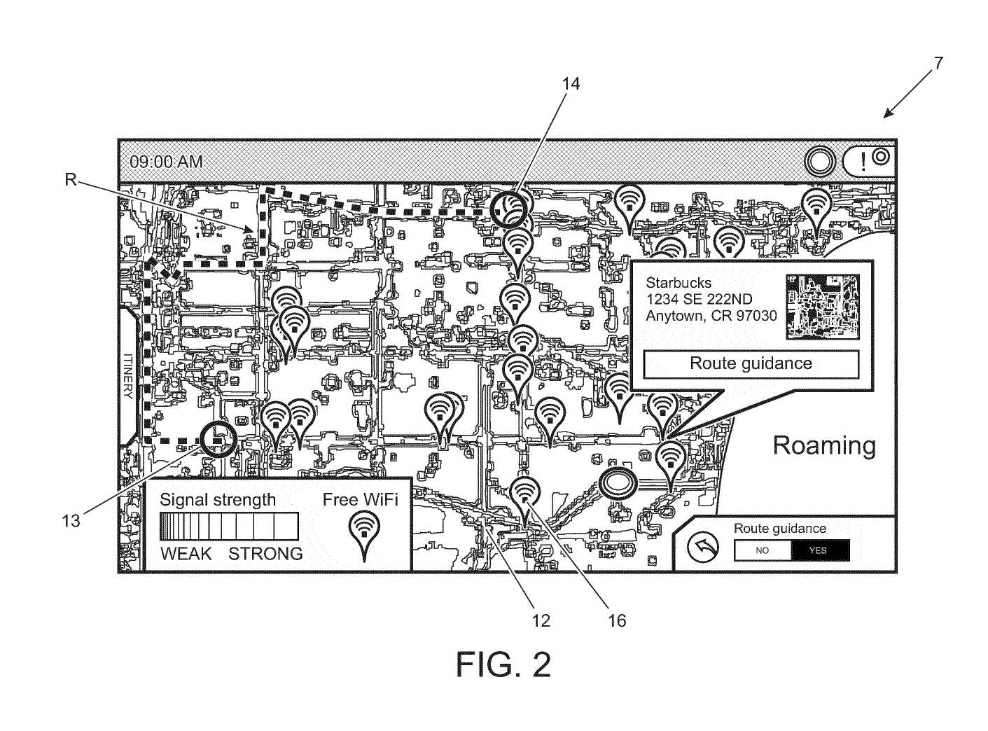

The display screen 6 is a conventional electronic display coupled to the electronic control unit 3 to display map and route information. The electronic control unit 3 can access the map database 9 and output a display signal to display the road network on the display screen 6. As shown in FIG. 2, the road network can be overlaid with a layer representing the available communications coverage (identified generally by the reference numeral 12) derived from the communications network database 10. In the present embodiment, the layer representing communications coverage is colour coded such that the strength of the available signal is indicated by colour; blue representing a low signal strength and red representing a high signal strength. The communications network database 10 can also define local area wireless connections, such as Wi-Fi connections. As shown in FIG. 2, the location of the local area wireless connections can also be overlaid onto the map.

The at least one electronic processor 7 implements a routing algorithm to plan a route to a destination which is typically specified by a user. By way of example, a dashed line is shown in FIG. 2 to represent a sample route R from a start location 13 to a destination 14. The routing algorithm accesses the map database 9 to plan one or more routes R from the start location 13 to the destination 14. The routing algorithm also accesses the communications network database 10 to assess connectivity to the wireless communication network along the one or more planned routes R. The routing algorithm can calculate an expected coverage (for example as a percentage x %) for the wireless network for a planned journey.

The routing algorithm can optionally select the route R satisfying particular connectivity criteria for a given journey. For example, the user can stipulate that the routing algorithm plans the route R to maintain connectivity to the wireless communication network for a defined portion of the route. The user can, for example, specify a connectivity threshold and the routing algorithm plans the route R to maintain connectivity for at least that portion of the route. Alternatively, or in addition, the user can specify that the routing algorithm plans the route R such that the signal strength remains above a defined threshold.

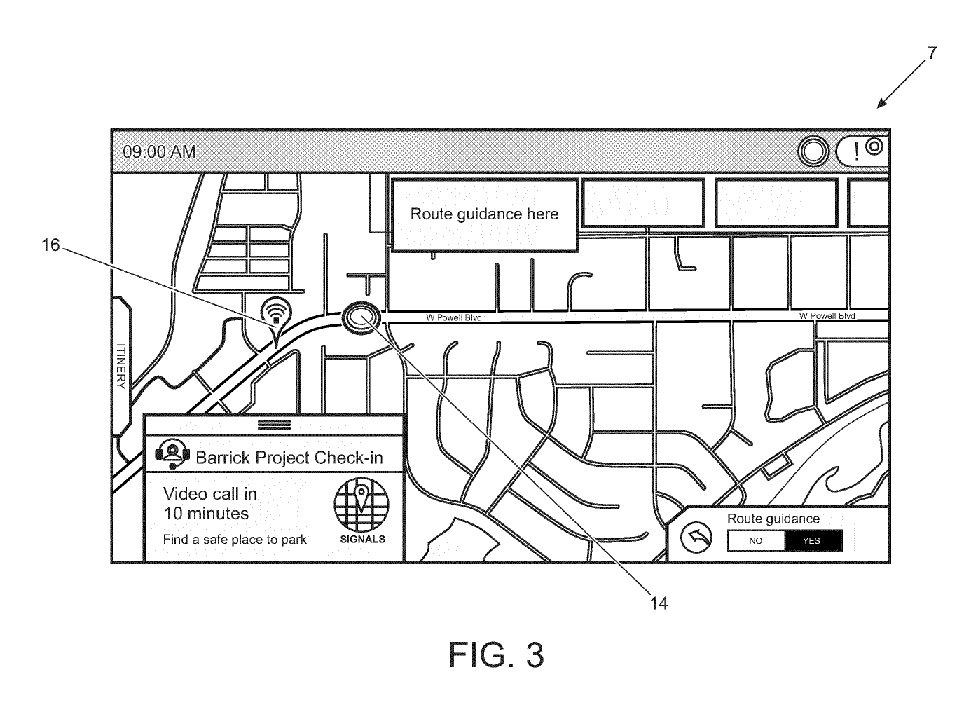

The electronic control unit 3 could optionally be connected to a diary database 15 defining user-scheduling information, for example timing for a telephone call or a video conference call. In this arrangement the routing algorithm can access the diary database 15 and plan the route R in dependence on the user-scheduling information. The routing algorithm can plan the route R such that the vehicle 2 is located in an area having adequate signal strength to complete a scheduled telephone call. Similarly, the routing algorithm can plan the route R to enable the vehicle 2 to stop proximal to a local area wireless connection 16 to complete the scheduled video conference call. This functionality is illustrated in FIG. 3 showing a current location 14 of the vehicle 2 in relation to the nearest local area wireless connection 16. The map database 9 can define traffic congestion information, for example defining time taken to travel along a length of road, to enable the routing algorithm to estimate journey times in order to coordinate the location of the vehicle 2 with the user-scheduling information.

The communications network database 10 can define additional network information, for example the type of a cellular network connection. The route planning apparatus 1 can be configured to display the different types of network information in separate layers. Layers can define for one or more of the following: 2G coverage, 3G coverage, 4G coverage, 5G coverage, local area wireless connection (such as Wi-Fi) coverage, dropped calls, network providers, signal strength, transfer speeds, etc. Each layer can be added over the navigation route to show the signal strength along a planned route to allow a user to avoid low coverage areas. By way of example, the signal strength 12 is represented by a single layer displayed over the road network in the arrangement illustrated in FIG. 2. The planned route R can be displayed as the topmost layer to aid clarity.

In use, the user specifies the destination (and optionally also the start location, if different from the current location of the vehicle 2) and the routing algorithm uses the map database 9 to plan the route R. The route R is displayed on the map network displayed on the display screen 6 in conventional manner. The user can optionally select one or more layers of network information to overlay onto the map network. The user can, for example, select network coverage to be displayed as a layer over the map network. The user can then choose a route (or modify a planned route) to enable the bandwidth to be maximised for the journey to help maintain connectivity to the wireless communication network. The user can also select a layer showing the location of the local area wireless connections 16.

As the vehicle 2 travels along the route R, the route planning apparatus 1 can access the diary database 15 and present updates linked to upcoming scheduled events (for example video conference call, phone calls, email responses, podcasts etc.) to provide a continuous connection to the wireless communication network. The routing algorithm could, for example, dynamically change the planned route R to compensate for factors such as traffic congestion which would mean that the vehicle 2 would otherwise be located in an area having poor network coverage when a telephone call is scheduled. If an occupant wishes to conduct a video call during a journey, the routing algorithm can plan a route to maintain a connection to the wireless communication network for the duration of the video call. If this is not possible, for example due to insufficient bandwidth over the wireless communication network, the route planning apparatus 1 can plan the route to incorporate a stop or parking location so that the vehicle 2 can park proximal to a local area wireless connection 16 to which the user can connect in order to conduct the video call. The route planning apparatus 1 could present one or more alternative local area wireless connection based on user preferences, for example to stop at a particular coffee shop.

The user can select a method of how connectivity data can be used: for example use of the average connectivity during the last 6 weeks; performance (best/worst), calls dropped, throughput etc.

When a user is making or taking an unscheduled voice or video call on a wireless network, the route planning apparatus can be aware of any upcoming areas having a reduced coverage that may cause the call to be dropped (for example in dependence on historical data). A notification can be output to the user in a timely manner to allow the driver to take appropriate steps, for example to take an alternative route.

It will be appreciated that various changes and modifications can be made to the apparatus and method described herein without departing from the scope of the present invention.

In a variant, the route planning apparatus could be configured dynamically to change a route to allow an ongoing telephone or video call to be conducted without interruption. For example, using the map database 9 and the communications network database 10, in conjunction with the location data generated by the navigation positioning system module 11, the routing algorithm can estimate when and/or where the connection to the wireless communication network will be lost. This could, for example, be determined with reference to historical data. The routing algorithm can dynamically change the planned route R to maintain the connection or can provide a warning before the connection is lost to allow the user to take appropriate action, for example to park the vehicle 2 or to take an alternate route to preserve the connection. The routing algorithm can be configured to provide this functionality automatically without requiring user input.

1. A method of planning a route to a destination, the method comprising:
accessing a map database defining a road network;
accessing a communications network database defining at least one network parameter for a wireless communication network;
using a routing algorithm to plan the route to the destination using the communications network database to estimate connectivity to the wireless communication network along the route; and
using a diary database to identify a scheduled time for an event requiring access to the wireless communication network,
wherein the routing algorithm is configured to plan the route such that a connection to the wireless communication network is available at the scheduled time, and wherein the routing algorithm is configured to schedule a stop at the scheduled time in a location where the connection to the wireless communication network is available.

2-3. (canceled)

4. The method of claim 1, wherein the routing algorithm uses the communications network database to plan the route to the destination such that the connection to the wireless communication network is maintained for at least a defined portion of the route.

5. The method of claim 1, wherein the routing algorithm is configured to estimate when and/or where the connection to the wireless communication will be lost and dynamically change the planned route to maintain the connection to the wireless communication network.

6. The method of claim 1, wherein the at least one network parameter defines one or more of the following: signal strength, transfer speeds, dropped call information, data quality, bandwidth, bit error rate, throughput, coverage, bandwidth and network capacity.

7. The method of claim 6, wherein the routing algorithm uses the communications network database to plan the route to the destination to avoid areas in which the at least one network parameter is below one or more defined thresholds.

8. The method of claim 6, wherein the routing algorithm uses the communications network database to plan the route to the destination to remain in areas in which the at least one network parameter is above one or more defined thresholds.

9. The method of claim 1, wherein the communications network database defines location information of one or more local area wireless connections.

10. The method of claim 1, wherein the at least one network parameter comprises historic data collected during one or more previous journeys.

11. The method of claim 1, further comprising displaying, via a display screen, the at least one network parameter for the wireless communication network over the road network.

12. The method of claim 11, wherein the at least one network parameter is displayed in one or more layers.

13. A route planning apparatus, comprising;
a controller comprising an electronic processor;
an electronic memory device electrically coupled to the electronic processor and having instructions stored therein,
wherein the electronic processor is configured to access the memory device and execute the instructions stored therein such that the electronic processor is configured to:
access a map database defining a road network;
access a communications network database defining at least one network parameter for a wireless communication network;
implement a routing algorithm to plan a route to a destination using the communications network database to estimate connectivity to the wireless communication network along the route; and
access a diary database to identify a scheduled time for an event requiring access to the wireless communication network,
wherein the routing algorithm is configured to plan the route such that a connection to the wireless communication network is available at the scheduled time, and wherein the routing algorithm is configured to schedule a stop at the scheduled time in a location where the connection to the wireless communication network is available.

14-15. (canceled)

16. The route planning apparatus of claim 13, wherein the routing algorithm uses the communications network database to plan the route to the destination such that the connection to the wireless communication network is maintained for at least a defined portion of the route.

17. The route planning apparatus of claim 13, wherein the routing algorithm is configured to estimate when and/or where the connection to the wireless communication will be lost and dynamically change the planned route to maintain the connection to the wireless communication network.

18. The route planning apparatus of claim 13, wherein the at least one network parameter defines one or more of the following: signal strength, transfer speeds, dropped call information, data quality, bandwidth, bit error rate, throughput, coverage, bandwidth and network capacity.

19. The route planning apparatus of claim 18, wherein the routing algorithm uses the communications network database to plan the route to the destination to avoid areas in which the at least one network parameter is below one or more defined thresholds.

20. The route planning apparatus of claim 18, wherein the routing algorithm uses the communications network database to plan the route to the destination to remain in areas in which the at least one network parameter is above one or more defined thresholds.

21. The route planning apparatus of claim 13, wherein the communications network database defines location information of one or more local area wireless connections.

22. The route planning apparatus of claim 13, wherein the at least one network parameter comprises historic data collected during one or more previous journeys.

23. The route planning apparatus of claim 13, further comprising a display screen configured to display the at least one network parameter overlaid onto the road network and/or the route.

24. The route planning apparatus of claim 23, wherein the at least one network parameter is displayed in one or more layers, each layer representing a different network parameter.

25. A vehicle comprising the route planning apparatus of claim 13.

26-27. (canceled)
